(19) United States
(12) Patent Application Publication
(10) Pub. No.: US 2018/0115100 A1
(43) Pub. Date: Apr. 26, 2018

(54) MOBILE TRANSFORMER BUSHING CONNECTION

(71) Applicant: SIEMENS AKTIENGESELLSCHAFT, MUNICH (DE)

(72) Inventors: MICHAEL BACHL, ALTENBERG (AT); WOLFGANG KAUFMANN, OTTENSHEIM (AT); GERNOT NEUMUELLER, LICHTENBERG (AT)

(21) Appl. No.: 15/420,600

(22) Filed: Jan. 31, 2017

(30) Foreign Application Priority Data
Oct. 24, 2016 (DE) 10 2016 220 852.7

(51) Int. Cl. H01R 13/00

(52) U.S. Cl. CPC H01R 13/005

(57) ABSTRACT

An electrical device can be connected to a high-voltage power grid in a flexible and cost-effective manner. There is provided an apparatus with a housing that is filled with an insulating fluid. A high-voltage bushing has a high-voltage conductor that extends through a bushing insulator and is fastened to the housing. Furthermore, a cable connection is provided on the housing in order to connect a high-voltage cable. A connecting conductor which is surrounded by the insulating liquid establishes a direct electrical connection between the cable connection and the high-voltage conductor of the high-voltage bushing in the housing. The high-voltage bushing is therefore no longer inserted into a tank which is filled with oil, but rather is part of a mobile apparatus which is connected to a winding in the tank by way of a cable.

The invention relates to an apparatus for connecting an electrical device to a high-voltage power grid.

The invention further relates to an electrical device for connection to a high-voltage power grid, comprising a tank in which a magnetizable core and a winding which surrounds the core at least in sections are arranged. The tank is filled with an insulating fluid.

Electrical devices, such as transformers or else chokes for example, which are designed for connection to a high-voltage power grid generally have high-voltage bushings which are fixedly connected to a tank which is filled with an insulating fluid. A plug-in end of the high-voltage bushing, which plug-in end protrudes into the oil chamber of the tank, is connected to a winding of the electrical device, whereas an outdoor connection of the high-voltage bushing, which outdoor connection is remote from the tank, serves for connection to an air-insulated high-voltage line. Since the tank of the electrical device is at ground potential, the outdoor connection to which a high voltage is applied has to be kept at a sufficient distance from the tank in order to avoid voltage flashovers. For this reason, the high-voltage bushings are dimensioned depending on the respective operating voltage, and therefore fitting and holding of the high-voltage bushing on the tank is complicated at relatively high voltages. In particular, the combination of tank and high-voltage bushing is expansive, and therefore not all locations are suitable for installing a transformer of this kind. Furthermore, flexibility in respect of positioning of the outdoor connections of the high-voltage bushing is increasingly required. However, this flexibility is not provided on account of the rigid connection between high-voltage bushing and tank.

The object of the invention is therefore to provide a way of connecting an electrical device of the kind cited in the introductory part to a high-voltage power grid in a quick, flexible and cost-effective manner.

The invention achieves this object by virtue of an apparatus of the above-mentioned type which has a housing which is filled with an insulating fluid, a high-voltage bushing which can be fastened to the housing and which has a high-voltage conductor which extends through a bushing insulator, a cable connection, which is provided on the housing, for connecting a high-voltage cable, and a connecting conductor which is held in the housing in an insulated manner and is surrounded by the insulating liquid and which connects the cable connection directly to the high-voltage conductor of the high-voltage bushing.

Proceeding from the electrical device cited in the introductory part, the invention achieves the object in that at least one winding is electrically connected to the cable connection of an apparatus of this kind.

The invention provides an apparatus which allows connection of a, for example air-insulated, high-voltage line to a winding which is arranged in the oil chamber of a tank of a transformer or a choke. For connection of the air-insulated high-voltage conductor, the high-voltage bushing expediently forms an outdoor connection which is connected to the high-voltage conductor of the high-voltage bushing. The high-voltage conductor extends through a bushing insulator which extends in a longitudinal direction and which, at that contact end which is remote from the outdoor connection, bears directly against the connecting conductor or makes contact with said connecting conductor with the interposition of a further line piece. In this case, the high-voltage bushing is fastened to the housing of the apparatus. To this end, the high-voltage bushing has a fastening section, for example in the form of a flange, which circumferentially surrounds the bushing insulator and is fixedly connected to said bushing insulator. The high-voltage bushing extends into the housing by way of an insertion section.

Within the scope of the invention, the high-voltage conductor of the high-voltage bushing is directly connected to the cable connection of the apparatus. Therefore, the apparatus according to the invention differs from a transformer or a choke. Within the meaning of the invention, the term “directly connected” indicates that the current path between the high-voltage conductor of the bushing and the cable connection, that is to say the connecting conductor, is free of inductive components such as windings or the like. Within the scope of the invention, the connecting conductor is a simple conductor connection which connects the bushing conductor to the cable connection without the interposition of inductive components. The connecting conductor is therefore a low-inductance conductor connection.

The connecting conductor is expediently of compact design and can advantageously be mechanically connected to the high-voltage bushing or else be mechanically fixedly connected to a bushing plug-in socket. Therefore, separately holding the connecting conductor in an insulated manner in the housing which is at ground potential is therefore rendered superfluous. As a result, the costs of the apparatus according to the invention are further reduced. The cable connection allows additional or alternative holding of the connecting conductor. The cable connection is likewise fixedly fitted to the housing, wherein it preferably extends to the connecting conductor with interposition of an insulating section, and therefore mechanically holds the connecting conductor on the housing.

The connecting conductor advantageously extends within a shielding electrode. The circumferential closed shielding electrode surrounds the connecting conductor in the manner of a crown, ring or tube. The shielding electrode serves to reduce high electrical field strengths and is at the same potential as the connecting conductor.

The cable connection is advantageously designed as a cable plug-in bushing. The cable plug-in socket has, for example, a flange section which is attached to the housing, wherein a bushing section which is composed of a solid insulating material extends in the direction of a metallic contact end. The metallic contact end is fixedly connected to the connecting conductor. If a cable with an insertion section of complementary shape is inserted into the cable plug-in bushing, the cable internal conductor makes contact with the metallic contact piece and therefore the connecting conductor. The design of the cable connection as a cable plug-in bushing simplifies and accelerates the fitting and, respectively, the connection of the apparatus according to the invention to an electrical device, such as a transformer or a choke for example.

The high-voltage bushing is advantageously electrically connected to the connecting conductor by means of a bushing plug-in socket. In line with this variant according to the invention, a bushing plug-in socket is provided, wherein the bushing plug-in socket advantageously has a fastening section for fastening to the housing. Furthermore, the bushing plug-in socket has a hollow receiving section which is composed of an electrically nonconductive insulating material which extends into the housing in the fastened position, wherein a metallic contact part which extends through the insulating material of the receiving section or lengthens said receiving section in the direction of the closed end region is arranged in a closed and tapered end region of the receiving section. According to this embodiment of the invention, each bushing plug-in socket has an open end approximately level with the housing wall which allows a plug-in section of the high-voltage bushing to be inserted. The receiving section extends, in the plug-in direction, from the fastening section of the bushing plug-in socket into the interior of the housing, wherein the receiving section is manufactured from an insulating material which provides the required dielectric strength between the contact piece, which is at a high-voltage potential during operation, and the housing which is also at ground potential during operation.

In order to provide the required dielectric strength, the receiving section and the plug-in section of the high-voltage bushing have a complementary shape in relation to one another, so that the plug-in section is pressed fixedly against the inner wall of the receiving section owing to the inherent weight of the high-voltage bushing, in order to avoid voltage peaks between the high-voltage bushing and the bushing plug-in socket in this way. According to this further development, the contact part of the bushing plug-in socket, which contact part is fixedly connected to the housing by means of the receiving section and the fastening section, is mechanically and electrically connected to the connecting conductor, so that the connecting conductor is mechanically connected to the housing by means of the bushing plug-in socket. Additional mechanical holding can be provided in a similar way by means of a cable plug-in bushing within the scope of the invention.

The housing is advantageously supported on rollers. On account of the arrangement of the housing on rollers, a mobile apparatus is provided, which itself can be easily and simply moved after fitting of the generally heavy high-voltage bushing. In this way, the fitting of an electrical device is simplified since this can be done in a quick and cost-effective manner.

The insulating fluid is advantageously a mineral oil, a vegetable oil, an ester oil, a synthetic oil or else a protective gas. However, in principle, the insulating fluid can be chosen as desired within the scope of the invention.

The high-voltage bushing expediently has a shielding section for reducing the electrical field strength during operation.

Since at least one winding of the electrical device according to the invention is connected to the cable connection of the apparatus described in detail above, the need to equip the tank with one or even several expansive high-voltage bushings is dispensed with within the scope of the invention. This allows quick and variable fitting and start-up of the electrical device according to the invention which is designed, for example, as a transformer or choke.

According to a further development which is expedient in this respect, the electrical device forms a device cable connection, wherein the cable connection of the apparatus is connected to the device cable connection by means of a cable. With the aid of this cable connection, the apparatus, which is lightweight in comparison to the electrical device, can be easily moved to the points at which particularly easy power grid connection is possible.

The electrical device according to the invention advantageously has a plurality of windings which are each connected to an apparatus according to the invention. If the electrical device is, for example, a transformer, all of the upper voltage windings can be connected to an apparatus according to the invention. The bushings which are connected to the lower voltage windings are usually relatively compact and therefore can be directly fastened to the tank. It goes without saying that it is also possible to connect each lower voltage winding to an apparatus according to the invention. If the electrical device according to the invention is designed as a choke, each winding is expediently connected to an apparatus according to the invention.

Further expedient refinements and advantages of the invention are the subject matter of the following description of exemplary embodiments of the invention with reference to the figures in the drawing, wherein identical reference signs refer to identically acting components, and wherein

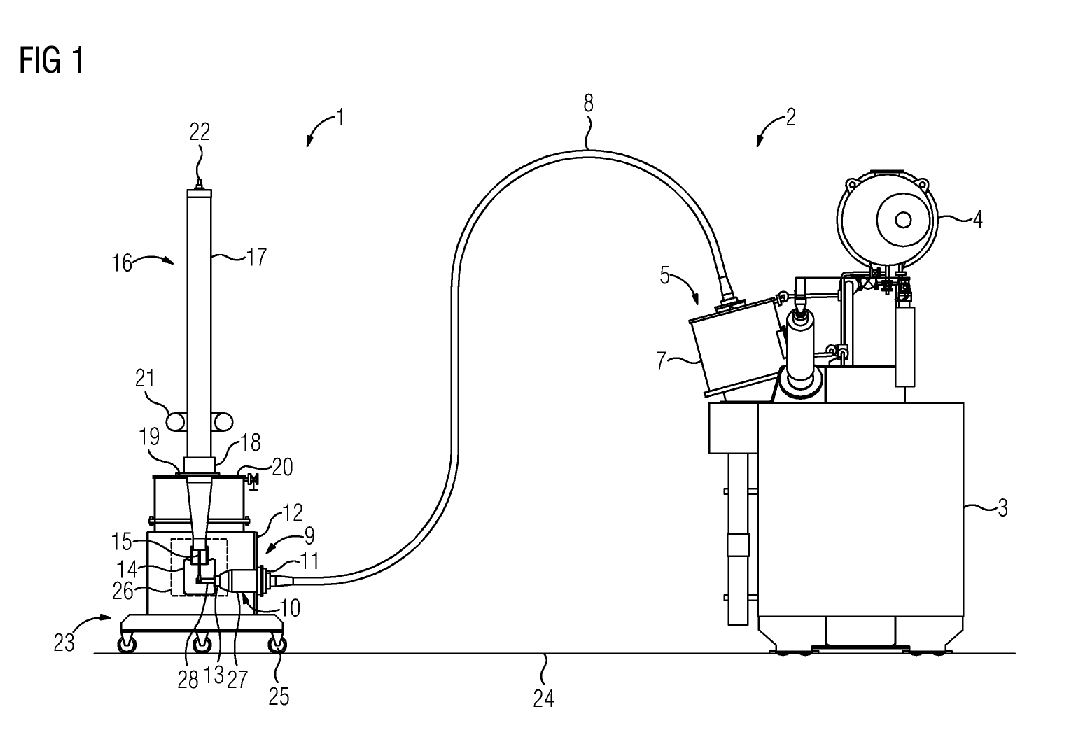

FIG. 1 schematically shows a side view of an exemplary embodiment of the apparatus according to the invention and an exemplary embodiment of the electrical device according to the invention, and

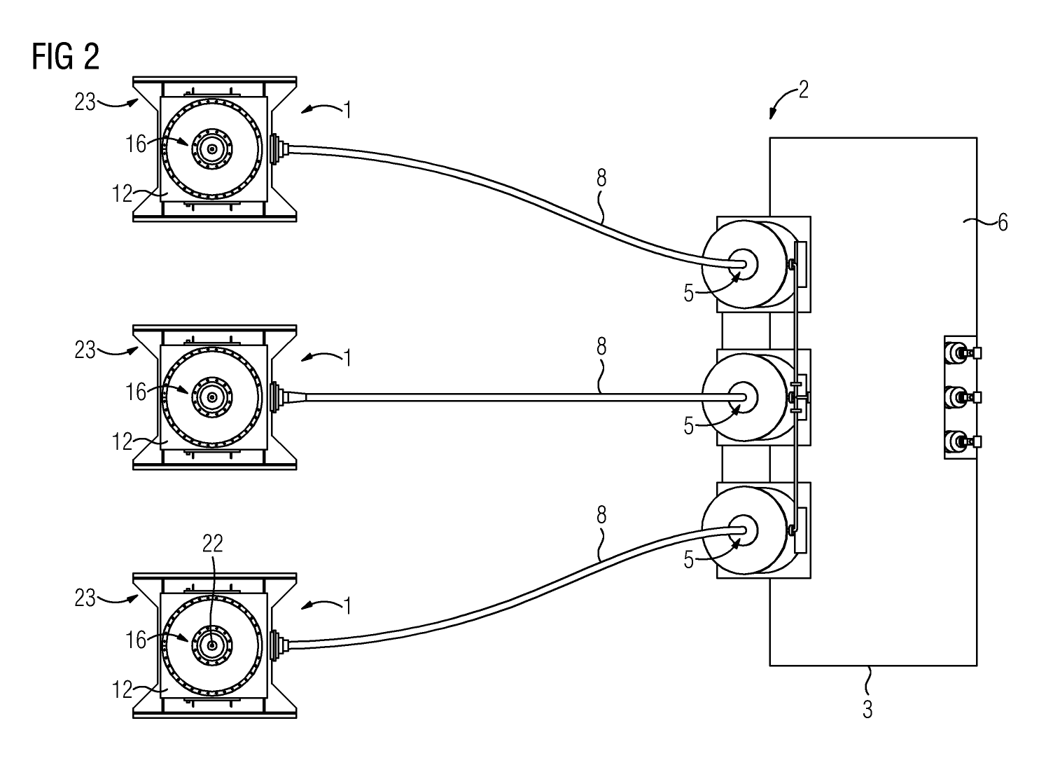

FIG. 2 schematically shows a plan view of the apparatus and the electrical device according to FIG. 1.

FIG. 1 shows an exemplary embodiment of the apparatus 1 according to the invention and an exemplary embodiment of the electrical device 2 according to the invention. The electrical device 2 is designed as a transformer in FIGS. 1 and 2 and comprises a tank 3 in which windings, not illustrated in the figures, and a magnetizable core are arranged. The core comprises steel sheets and forms limbs which are surrounded by a lower and an upper voltage winding. The limbs are connected to one another by means of an upper and a lower yoke. In order to insulate and cool the windings, the tank 3 is filled with an insulating fluid, for example a mineral oil or an ester oil, wherein an expansion vessel 4 is arranged above the tank 3, said expansion vessel being connected to the interior of the tank so that temperature-related fluctuations in the volume of the insulating fluid can be reliably absorbed by the expansion vessel 4.

In order to improve cooling, the tank is equipped with cooling fins, not illustrated in the figures. Furthermore, it is possible within the scope of the invention to actively or passively recirculate the insulating fluid by means of a cooling device, likewise not illustrated in the figures.

The electrical device 2 further has a device cable connection 5 which is arranged above a cover 6 of the tank 3 and forms a dome-like housing 7. A winding connection line which is connected to the upper voltage winding extends from the inside into the dome-like housing 7 and there is connected to the insertion section of a cable 8. The device cable connection 5 ensures the electrical connection of the insulated internal conductor of the cable 8 to one of the windings of the transformer 2. The cable 8 extends from the device cable connection 5 to a plug-in end 9 which is inserted into a cable plug-in bushing 10 of the apparatus 1. The cable bushing 10 is mechanically fastened to a housing 12 of the apparatus 1 by way of a cable fastening section 11. A cable insertion section 27 which is composed of insulating material extends from the cable fastening section 11 to a cable end contact 13 which is connected to a high-voltage conductor 15 of a high-voltage bushing 16 by means of an electrically conductive connecting conductor 28 which extends within a shielding electrode 14, wherein the high-voltage conductor 15 extends through an electrically nonconductive bushing insulator 17. The bushing insulator 17 is surrounded by a fastening section 18 which is of ring-like design and which forms a flange 19 by way of which the fastening section 18 and therefore the entire high-voltage bushing 16 are fixedly fitted to the housing 12.

The housing 12, which is hollow on the inside, has a substructure which is in the form of a box here and which is adjoined by a circular-cylindrical bushing extension 20. However, in principle, the configuration of the housing can be chosen as desired within the scope of the invention. Furthermore, an optional shielding ring 21 for reducing the electrical field strengths which are produced during operation of the electrical device 2 is shown in this exemplary embodiment. At that end which is remote from the housing 12, the high-voltage bushing 16 has an outdoor connection 22 which is provided for connection of an air-insulated high-voltage conductor. The housing 12 of the apparatus 1 is filled with an insulating fluid, for example a mineral oil, an ester oil, a vegetable oil or the like, which provides the required insulation between the housing 12, which is at ground potential, and the components to which high voltage is applied during operation, such as the outdoor connection 22, the high-voltage conductor 15, the connecting conductor 28, the shielding electrode, the contact part 13 and the internal conductor of the cable 8.

The housing 12 is further supported on a roller carriage 23 which has rollers 25 which roll on a floor surface 24. The entire apparatus 1 is therefore supported on the floor 24 by means of the rollers 25 and can therefore be easily moved. On account of the cable connection between the apparatus 1 and the tank 3, it is necessary to maintain only a minimum distance between the outdoor connection 22 and components at ground potential. The cable 8 expediently comprises an internal conductor which is sheathed by an electrically insulating solid.

In order to facilitate fitting, the housing 12 is provided with a fitting opening 26 which can be opened if required in order to grant access to the interior of the housing 12.

FIG. 2 shows a plan view of the electrical device 2 and the apparatus 1 according to FIG. 1. Said figure shows that the transformer 2 is of three-phase design and has three cable connections 5, wherein the cable 8 which is inserted into the bushing cable connection 5 is in each case electrically connected to a winding of the transformer 2.

An apparatus 1 is provided for each bushing cable connection 5. The apparatus 1 and the electrical device 2 according to the invention can therefore be easily transported and quickly fitted on site.

1-10. (canceled)

11. An apparatus for connecting an electrical device to a high-voltage power grid, the apparatus comprising:
a housing filled with an insulating fluid;
a high-voltage bushing to be fastened to said housing, said high-voltage bushing having a high-voltage conductor that extends through a bushing insulator;
a cable connection disposed on said housing, for connecting a high-voltage cable; and
a connecting conductor held in said housing in an insulated relationship and surrounded by said insulating fluid, said connecting conductor connecting said cable connection directly to said high-voltage conductor of said high-voltage bushing.

12. The apparatus according to claim 11, wherein said cable connection is a cable plug-in socket.

13. The apparatus according to claim 11, wherein said high-voltage bushing is electrically connected to said connecting conductor by way of a bushing plug-in socket.

14. The apparatus according to claim 11, wherein said housing is supported on rollers.

15. The apparatus according to claim 11, wherein said insulating fluid is a fluid selected from the group consisting of a mineral oil, a vegetable oil, an ester oil, a synthetic oil and a protective gas.

16. The apparatus according to claim 11, which comprises a shielding electrode and wherein said connecting conductor extends within said shielding electrode at least in sections.

17. The apparatus according to claim 11, which further comprises an expansion vessel fluidically connected with said housing.

18. An electrical device for connection to a high-voltage power grid, the electrical device comprising:
a tank filled with an insulating fluid;
a magnetizable core and at least one winding that surrounds said core at least in sections disposed in said tank; and
an apparatus according to claim 11;
wherein said at least one winding is electrically connected to said cable connection of said apparatus.

19. The electrical device according to claim 18, which comprises a device cable connection formed on said tank and a cable connecting said cable connection of said apparatus to said device cable connection on said tank.

20. The electrical device according to claim 18, wherein said at least one winding is one of a plurality of windings and said apparatus is one of a plurality of said apparatus, and wherein each of said windings is connected to a respective said apparatus.
